(19) United States
(12) Patent Application Publication
(10) Pub. No.: US 2011/0245870 A1
(43) Pub. Date: Oct. 6, 2011

(54) Teether Rings

(76) Inventor: Charlotte McKinney, Waco, TX (US)

(21) Appl. No.: 13/080,464

(22) Filed: Apr. 5, 2011

Related U.S. Application Data
(60) Provisional application No. 61/320,781, filed on Apr. 5, 2010.

(51) Int. Cl. A61J 17/00

(52) U.S. Cl. 606/235

(57) ABSTRACT

An infant teething toy device is provided that comprises a set of one to four horizontally aligned rings with a teething surface fixedly attached to each. The rings are open at their base for adjustably securing the device to the fingers of an infant user. The attached teething surface may be an oval shape which extends across the length of the child's hand, or alternatively it may comprise a set of small teething surfaces individually attached to finger rings. The teething surfaces may have surface texture consisting of nubs or grooves to facilitate stimulation of a child's gums. A variety of teething surface shapes and textures are provided to assist the child in alleviating differing levels of discomfort and prevent the child from chewing or biting his or her fingers.

### CROSS REFERENCE TO RELATED APPLICATION

This application claims the benefit of U.S. Provisional Application No. 61/320781 filed on Apr. 5, 2010, entitled “Teether Rings.”

### BACKGROUND OF THE INVENTION

1. Field of the Invention

The present invention relates to an infant teething toy device that can be adjustably placed on the fingers of a child's hand. Further, the device provides a means for stimulating a child's gums while teething, for pain alleviation and prevention of finger sucking or biting.

Teething ring devices are well known in the art and come in a variety of shapes and sizes. They are used around the world to alleviate the pain associated with teeth cutting through an infant's gums. These devices are typically placed in the mouth of an infant who then chews on the teething toy to stimulate the gums and aid the teeth in cutting through the gum line. Infant caregivers will often carry such teething devices with them and provide the devices to the infant when the infant is in discomfort related to teething.

Traditional teething devices rely on the baby or the caregiver to hold the toy steady while the baby chews. This approach is problematic because of the lack of dexterity possessed by most infants. When an infant uses a teething device and then drops it, the device can become contaminated by dirt and debris. This dirt and debris is potentially harmful to an infant and must be cleaned off prior to the continued use. Delays experienced while cleaning a teething toy can result in extended discomfort or pain for the infant. To reduce the amount of discomfort they experience, infants will often resort to chewing on their hands or knuckles if no teething device is available. Over time this practice can lead to damage to a baby's skin and hands.

2. Description of the Prior Art

The prior art contains a number of baby teething devices. These devices have familiar design and structural elements for the purposes of relieving the discomfort associated with baby teething. However they are not adapted to prevent an infant from chewing on his or her knuckles.

Keller, U.S. Patent Publication No. 2003/0233121 discloses a teething ring of oval shape that is connected to a fabric loop. The fabric loop is placed around a wearer's hand for the purpose of preventing the device from falling on the floor.

Rosenthal, U.S. Patent Publication No. 2010/0016896 discloses a set of teething rings which are joined consecutively by looping one through the center cavity of the next ring to form a set of links. These links may be worn around the wrist of a user to prevent the teething toy from falling on the ground.

Spivack, U.S. Pat. No. 3,690,324 discloses an infant teething device comprised of a tube of one or more intertwined loops. The device can be filled with material or be hollow, and may be worn on the wrist of a user like a bracelet.

The infant teething devices disclosed by the prior art do not address the need to prevent a child from chewing on his or her own hand. Additionally they are adapted to be worn by a caregiver for assisting the child alleviate pain associated with teething, and not on the hand or wrist of the infant themselves.

The current invention relates to a device worn on the fingers of an infant for the purposes of relieving pain associated with new teeth cutting through the gum line, preventing the child from dropping the device, and preventing the child from chewing on his or her own hand. It substantially diverges in design elements from the prior art and consequently it is clear that there is a need in the art for an improvement to the existing baby teething toy devices. In this regard the instant invention substantially fulfills these needs.

### SUMMARY OF THE INVENTION

In view of the foregoing disadvantages inherent in the known types of infant teething toys now present in the prior art, the present invention provides a new hand worn device for protecting an infant's knuckles wherein the same can be utilized for providing convenience for the user when placed on the hand of a teething infant. The device comprises a set of one or more aligned rings upon which an infant teething toy is fixedly attached. The rings are open at the bottom and made of the same durable material as the teething toy. They are also flexible so that they may be placed on the hands of children who may have varying fingers sizes. A number of materials may be used in the construction of the toy itself, such as rubber, plastic, or any other suitable material that is not harmful to the baby and fulfills the requirements of the present invention.

The teething toy is a chewable surface superior to an open ring and may comprise a large oval shape that covers the top of the finger rings, extending approximately the width of a child's hand. The surface of the teething toy is covered in nubs or alternatively, grooves that when chewed on by a teething infant will stimulate the gums. To further the purpose of alleviating gum pain the teething toy surface may be solid throughout, or hollow and filled with liquid to provide less resistance to infants with more intense pain.

Another form of the invention contemplates substitution of the large oval shape with individual teething surfaces attached atop individual finger rings. The may be used individually, independently, or joined together at their sides. Each individual toy may have a different surface texture and color to provide a variety of oral stimulation devices to the teething infant dependent upon his or her preference at the time of use.

Either embodiment of the invention is suited for the purpose of reducing both the frequency with which a teething infant chews on his or her own hand, and the frequency with which the teething toy is dropped on the floor. When placed on the fingers of an infant, the teething toy device covers part of the child's hand and knuckles providing an aesthetically interesting way for a child to reduce gum pain by chewing on the teething toy surface or surfaces. Since the teething toy is secured to the child's fingers, the child is less likely to drop the toy onto the floor. Reduction in the number of times the toy is dropped will result in less time that the child is without the use of the teething toy and thus will further the purpose of alleviating the infant's discomfort.

It is therefore an object of the present invention to provide a new and improved infant teething toy device that has all of the advantages of the prior art and none of the disadvantages.

Another object of the present invention is to provide a new and improved infant teething toy device that has resilient and durable construction.

Yet another object of the present invention is to provide a new and improved infant teething toy device that has a teething toy surface that is placed on a baby's hand to prevent the baby from damaging his or her knuckles while chewing.

Still another object of the present invention is to provide a new and improved infant teething toy device that attaches to the wearers hand by a set of flexible, open finger rings that will insure the device remains in place while in use and does not fall on the ground where it can collect dirt and debris.

Another object of the present invention is to provide a new and improved teething toy device having a variety of teething toy surfaces to meet the changing discomfort levels of a teething infant.

Other objects, features and advantages of the present invention will become apparent from the following detailed description taken in conjunction with the accompanying drawings.

### BRIEF DESCRIPTIONS OF THE DRAWINGS

The above invention will be better understood and the objects set forth above, as well as other objects not stated above, will become more apparent after a study of the following detailed description thereof. Such description makes use of the annexed drawings wherein:

FIG. 1 is a top perspective view of a first embodiment of the infant teething toy device, individually worn on the fingers of a child.

FIG. 2 is a bottom perspective view of a first embodiment of the infant teething toy device, individually worn on the fingers of a child.

FIG. 3 is a top view of a second embodiment of the teething toy device wherein each teething toy is connected between finger rings, each toy having a different surface feature or contour.

FIG. 4 is a side view of the first embodiment teething toy device with teething toy element independently attached to each finger, each toy having a different surface feature or contour.

FIG. 5 is a top view of the third embodiment of the disclosed invention, wherein an oval teething toy element is provided across all fingers, covered with plurality of soft nubs.

FIG. 6 is a side view of the third embodiment of the disclosed invention.

### DETAILED DESCRIPTION OF THE INVENTION

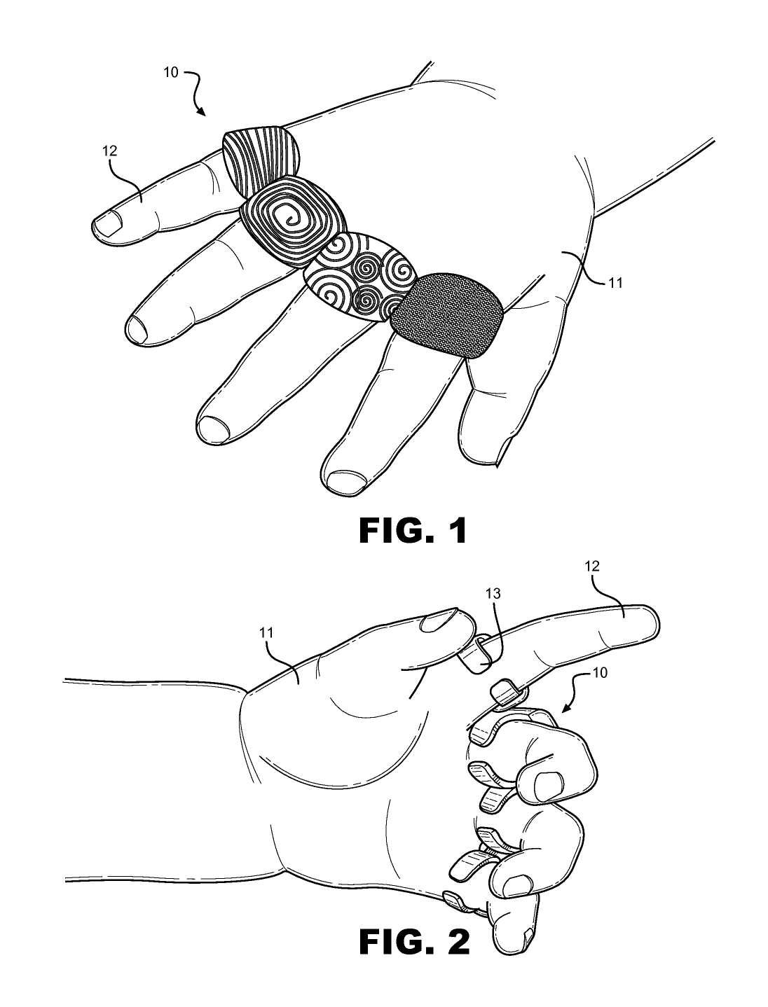

Referring now to FIGS. 1 & 2, there is shown a first embodiment of the present invention consisting of an infant teething toy device 10 worn on the hand 11 of a child. The teething toy device 10 is adjustably secured to the child's fingers 12 by a set of open rings 13 to accommodate the varying sizes of a child's fingers 12. The rings 13 are aligned in a row to create a comfortable fit when the device 10 is placed on each individual finger. When worn by an infant, the teething toy device 10 should be approximately the width of the child's hand 12. The

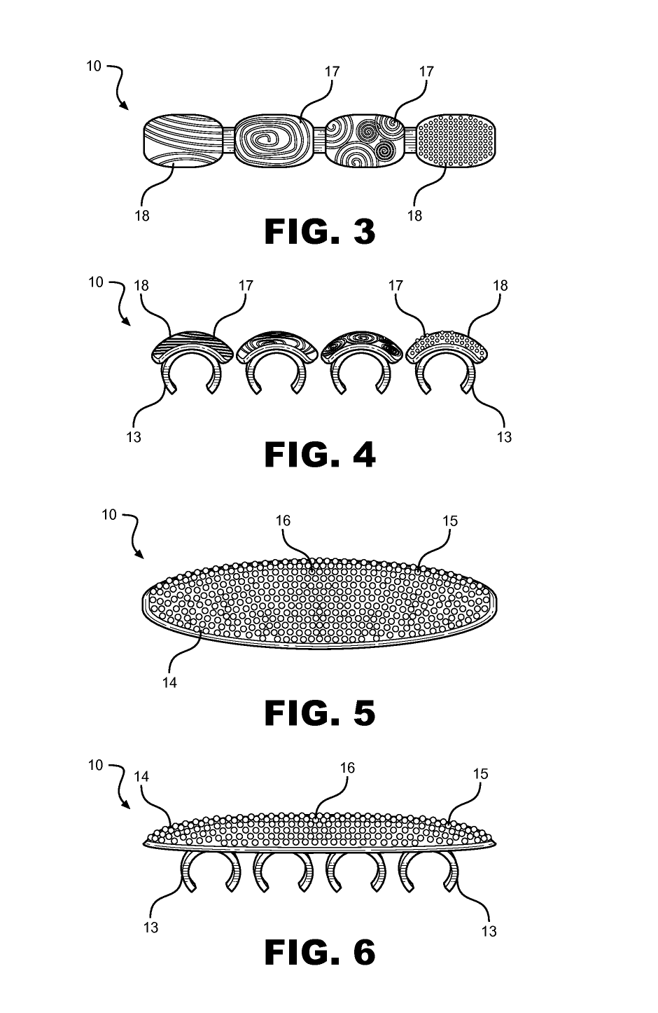

With respect to FIGS. 3 & 4 there are shown two embodiments of the infant teething toy device 10. A set of small teething surfaces 17 are superior to individual finger rings 13. In FIG. 4 the teething surfaces 17 are unattached for individual placement on a child's fingers 12 according to the usage preferences of the child. In FIG. 3 the teething surfaces 17 are joined together at their sides and aligned to create a band of teething surfaces 17 across the infant's hand 11. Each of the teething surfaces 17 may have a different texture to its outer portion 18. Variation in an outer portion's 18 textures offers different chewing experiences for the child user, facilitating reduction in differing levels of gum pain discomfort. FIG. 3 shows a preferred embodiment of the present invention, in which the individual teething surfaces 17 are attached to ensure alignment and prevent inadvertent swallowing of an individual teething toy.

Referring now to FIGS. 5 & 6 there is shown a top and side view of a third embodiment of the infant teething toy device 10. An oval shaped teething surface 14 is affixed superior to three to four finger rings 13. The rings 13 may be attached to each other at the sides or spaced apart across the bottom surface of the oval. The oval shaped teething surface outer portion 15 has a patterned texture comprising either small nubs 16 or grooves. The textured contour of the outer portion 15 further stimulates the gums of the child.

Teething surfaces 14, 17 of any of the disclosed embodiments may be solid throughout or filled with a liquid such as water. Differences in structure create variations in resistance for a chewing infant. These varied resistance types are appropriate for different levels of gum pain experienced by a child. Consequently, one embodiment of the teething toy device 10 may be more appropriate than another in a given situation. The device 10 itself may be constructed of any durable, flexible, non-toxic material, including rubber, plastic or other suitable material. It is not necessary for the teething surface 14, 17 to be made of the same material as the finger rings 13, however the entire device may be constructed of the same material for ease in manufacturing. The elements of the device 10 may also be made from a plurality of different colored materials to increase the aesthetic appeal of the teething toy device 10 to an infant user.

In use a caregiver secures the infant teething toy device 10 to the hand 11 of an infant by placing each of members of the set of rings 13 around the fingers 12 of the infant. The infant can then chew on the teething surface 14, 17 to alleviate gum pain experienced by the cutting of teeth through the gums. The placement of the device 10 on the hand 11 of a child decreases the frequency with which the child will chew on his or her own hand 10, thus reducing the risk of injury to the child's knuckles. Securing the teething toy device 10 to the fingers 12 of the child reduces the risk that the toy will fall on the floor and gather dirt and debris that could potentially harm the child if eaten. Attaching the device to the child's hand as opposed to a caregiver's hand also reduces the amount of oversight and supervision required from the caregiver.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim the following:

1) An infant teething device worn on an infant's fingers while teething, comprising:
a chewable surface superior to an open ring attachment;
said surface having a patterned texture;
said ring attachment being adapted to adjustably fit on a child's fingers;

2) The infant teething device of claim 1, wherein:
a set of one to four said chewable surfaces aligned along said child's fingers.

3) The infant teething device of claim 1, wherein:
said surface is formed over an enclosure filled with liquid.

4) The infant teething device of claim 1, wherein:
said patterned texture is small nubs.

5) The infant teething device of claim 1, wherein:
said patterned texture is notched grooves.

6) The infant teething device of claim 1, wherein:
said rings are attached together at their sides.

7) The infant teething device of claim 1, wherein:
said teething device is made of rubber.

8) The infant teething device of claim 1, wherein:
said teething device is made of plastic.

9) An infant teething device worn on an infant's fingers while teething, comprising:
a chewable surface superior to a plurality of open ring attachments;
said surface having a patterned texture;
said surface having an oval shape;
said rings adapted to adjustably fit on a child's fingers.

10) The infant teething device of claim 9, wherein:
said surface is formed over an enclosure filled with liquid.

11) The infant teething device of claim 9, wherein:
said patterned texture is small nubs.

12) The infant teething device of claim 9, wherein:
said patterned texture is notched grooves.

13) The infant teething device of claim 9, wherein:
said teething device is made of rubber.

14) The infant teething device of claim 9, wherein:
said teething device is made of plastic.

15) An infant teething device worn on an infant's fingers while teething, comprising:
a plurality of chewable surfaces superior to open ring attachments;
said surfaces having a patterned texture;
said surfaces attached to one another along their sides;
said ring attachments being adapted to adjustably fit on a child's fingers;
said plurality of surfaces comprising a set of two to four surfaces.

16) The infant teething device of claim 15, wherein:
said individual surfaces having different patterned textures.

17) The infant teething device of claim 15, wherein:
said patterned texture is small nubs.

18) The infant teething device of claim 15, wherein:
said patterned texture is notched grooves.

19) The infant teething device of claim 15, wherein:
said teething device is made of rubber.

20) The infant teething device of claim 15, wherein:
said teething device is made of plastic.
